(19) United States
(12) Patent Application Publication
(10) Pub. No.: US 2026/0202670 A1
(43) Pub. Date: Jul. 16, 2026

(54) ATTACHMENT STRUCTURE OF HEAD-UP DISPLAY DEVICE TO VEHICLE

(71) Applicant: Yazaki Corporation, Tokyo (JP)

(72) Inventors: Yuki MIYOSHI, Shizuoka (JP); Yasuhiro KATSUMATA, Shizuoka (JP); Naoto TSUBAKIHARA, Shizuoka (JP); Hiroshi SANO, Shizuoka (JP); Takahiro OSAWA, Shizuoka (JP); Yu KOBAYASHI, Shizuoka (JP); Tetsuya SUGANUMA, Shizuoka (JP)

(73) Assignee: Yazaki Corporation, Tokyo (JP)

(21) Appl. No.: 19/134,854

(22) PCT Filed: Oct. 2, 2024
(86) PCT No.: PCT/JP2024/035206

§ 371 Date: Jun. 2, 2025

(30) Foreign Application Priority Data
Oct. 24, 2023 (JP) 2023-182358

(51) Int. Cl. G02B 27/01; G02B 27/64

(52) U.S. Cl. CPC G02B 27/0149; G02B 27/646

(57) ABSTRACT

It is to provide an attachment structure of a head-up display device to a vehicle that can reduce the virtual image blurring occurred due to vibrations. The HUD device (1) includes a housing (70), a display device (30), a plane mirror (21), a concave mirror (20), and a control portion (60). The concave mirror (20) is supported by the housing (70) to be freely rotated. In the attachment structure (101) of the HUD device (1) to the vehicle, in order to reduce the virtual image blurring due to the vibrations, a first elastic member (42) and a second elastic member (43) are provided. The first elastic member (42) is provided between a protrusion portion (41) provided in the housing (70) and a vehicle body structure (100). The second elastic member (43) is provided between a rear surface (a surface not at the side of the reflection surface) of the concave mirror (20) and the internal surface of the housing (70).

### TECHNICAL FIELD

The present invention relates to an attachment structure of a head-up display device to a vehicle.

### BACKGROUND ART

It is known that a head-up display device attached to a vehicle is configured to display vehicle travelling information or the like as a virtual image to a driver at a front side (vehicle outside) of a window shield (see Patent Document 1).

### CITATION LIST

### Patent Documents

[Patent Document 1] JP 2023-60690A

### SUMMARY OF THE INVENTION

### Technical Problem

There is a case in which a conventional head-up display device may cause vibrations (vibrations that are not synchronized with the vibrations of a vehicle) due to some looseness in an attachment structure to the vehicle, which can lead to a blurring in the displayed virtual image. In a case in which the virtual image blurring occurs, it is impossible to correctly read the vehicle travelling information displayed by the virtual image so as to obstruct the driving by the driver.

Therefore, a purpose of the present invention is to provide an attachment structure of a head-up display device to a vehicle that is able to reduce the virtual image blurring by the vibrations.

### Solution to Problem

The present invention is characterized in that in an attachment structure of a head-up display device to a vehicle, between a housing of the head-up display device and the vehicle, an elastic member being in contact therewith is arranged.

### Effect of the Invention

According to the present invention, it is possible to suppress the vibrations that are not synchronized with the vibrations of a vehicle from occurring so as to reduce the virtual image blurring.

### BRIEF DESCRIPTION OF THE DRAWINGS

FIG. 1 is a schematic view showing a mounting aspect of a head-up display device according to an embodiment of the present invention.

FIG. 2 is a schematic view showing an attachment structure of the head-up display device in FIG. 1 to a vehicle.

FIG. 3 is a perspective view of the head-up display device in FIG. 2.

FIG. 4 is a perspective view of the head-up display device in FIG. 3 which is viewed from another angle.

FIG. 5 is a view for describing the attachment structure of the head-up display device in FIG. 4 to the vehicle.

FIG. 6 is an exploded view of the head-up display device in FIG. 5.

### DESCRIPTION OF EMBODIMENTS

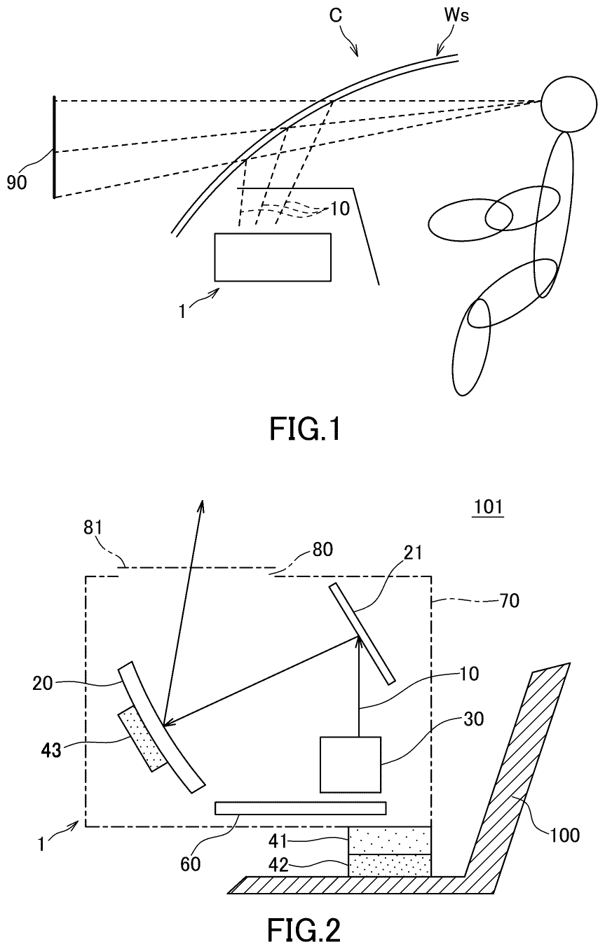

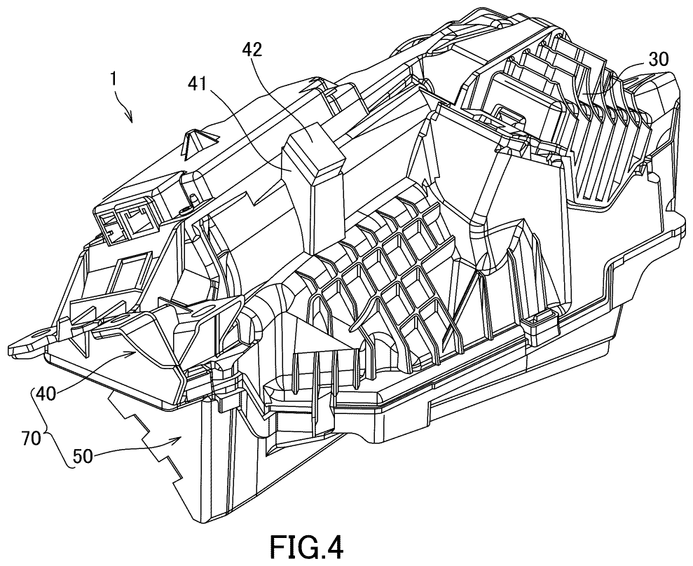

“An attachment structure of a head-up display device to a vehicle” according to an embodiment of the present invention will be described by referring to FIG. 1 to FIG. 6.

FIG. 1 is a schematic view for showing a mounting aspect of a head-up display device 1 (hereinafter recited as a “HUD device”) according to an embodiment of the present invention. As shown in FIG. 1, the HUD device 1 is accommodated inside an instrument panel of a vehicle C as a configuration to display vehicle travelling information and the like as a virtual image 90 to a driver at a front side (vehicle outside) of a window shield Ws by projecting the display light 10 on the window shield Ws.

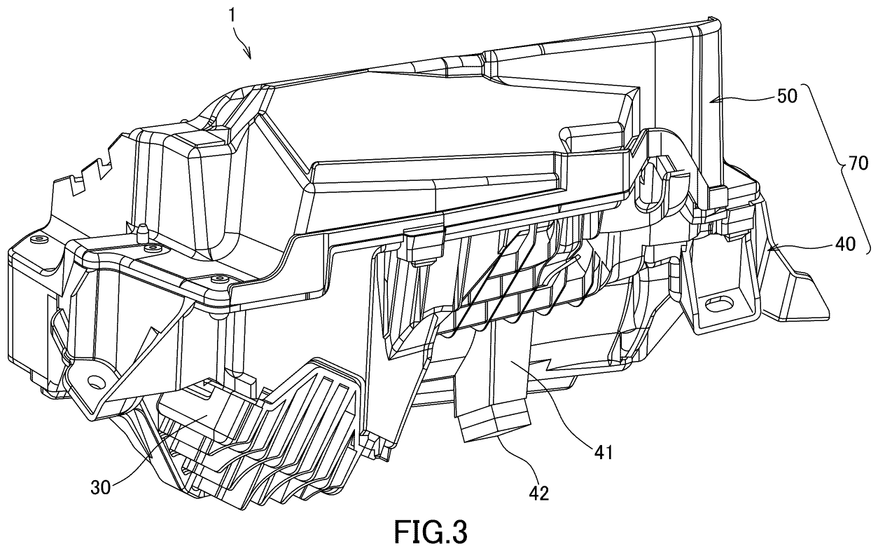

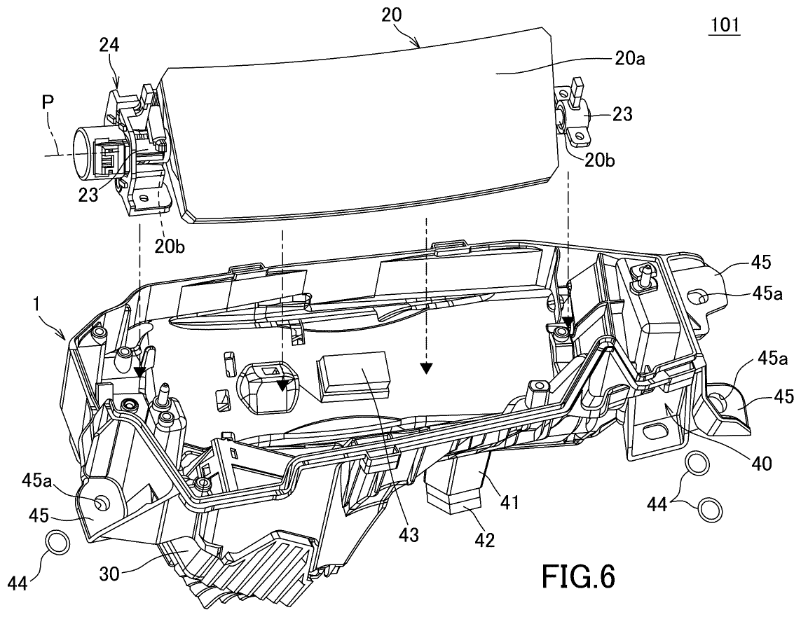

FIG. 2 is a schematic view showing an attachment structure 101 of the HUD device 1 in FIG. 1 to the vehicle C. The reference sign 100 in FIG. 2 refers to the vehicle body structure inside the instrument panel. FIG. 3 to FIG. 5 are external views of the HUD device 1, and FIG. 6 is an exploded view of the HUD device 1.

As shown in FIG. 2, the HUD device 1 includes a housing 70, a display device 30, a plane mirror 21, a concave mirror (equivalent as a “reflection member”) 20, and a control portion 60. Also, as shown in FIG. 6, the HUD device 1 includes a pair of support members 23 for supporting the concave mirror 20 to be freely rotatable, and a rotation means 24 for applying a rotation force to the concave mirror 20. The display device 30 can be adopted as a liquid crystal display, for example. The control portion 60 controls the display device 30 and the rotation means 24.

As shown in FIG. 3 to FIG. 5, the housing 70 includes a lower case 40 and an upper case 50 that are assembled with each other, and a cover member 81 for blocking an opening portion 80 formed in the upper case 50. The housing 70 is configured such that the lower case 40 is positioned at a lower side while the upper case 50 is at an upper side in a state in which the housing 70 is attached to the vehicle C. The lower case 40 and the upper case 50 are configured from the light-shielding synthetic resin, and the cover member 81 is configured from the translucency synthetic resin.

In the lower case 40, a plurality of brackets 45 are fixed to the vehicle body structure 100 by bolts. The reference sign 45a in FIG. 6 is a bolt insertion hole. Also, in the lower case 40, a protrusion portion 41 in a strut shape protruding downward is arranged therein.

The display device 30, the plane mirror 21, and the control portion 60 are accommodated inside the housing 70 and fixed to the housing 70. Also, a part of the display device 30 is positioned outside the lower case 40. The concave mirror 20 is accommodated in the housing 70 while being supported by the lower case 40, via the above-described pair of support members 23, to be freely rotatable.

The concave mirror 20 will be further described in detail. The concave mirror 20 includes a main body portion 20a in a rectangular plate shape and a pair of shaft portions 20b protruding from both end portions of the main body portion 20a respectively. In the main body portion 20a, a reflection surface opposite the plane mirror 21 is formed in a concave plane. The pair of shaft portions 20b are supported by a pair of support members 23 to be freely rotatable. The dot-dash line P in FIG. 6 indicates a rotation center of the concave mirror 20. The pair of support members 23 are fixed to the inside of the lower case 40 by bolts. The above-described rotation means 24 includes a motor, a gear for transmitting the rotation force of this motor to the shaft portion 20b and the like.

As shown in FIG. 2, the display device 30 irradiates the display light 10 toward the plane mirror 21. This display light 10 is reflected by the plane mirror 21, then reflected by the concave mirror 20, and transmitted through the cover member 81 to be projected on the window shield Ws. Then, as shown in FIG. 1, the display light 10 reflected at the window shield Ws is toward the eyes of the driver on the driver seat. The driver recognizes the display light 10 that has entered his eyes as a virtual image 90 displayed at the front side of the wind shield Ws (the vehicle outside).

This HUD device 1 can change the projecting position of the display light 10 to the window shield Ws corresponding to the eye level of the driver seated in the driver seat. When the driver operates an operation portion that is not shown in figures, the control portion 60 drives the rotation means 24 in response to an operation signal from this operation portion to rotate the concave mirror 20. Accordingly, the projection position of the display light 10 to the window shield Ws is changed.

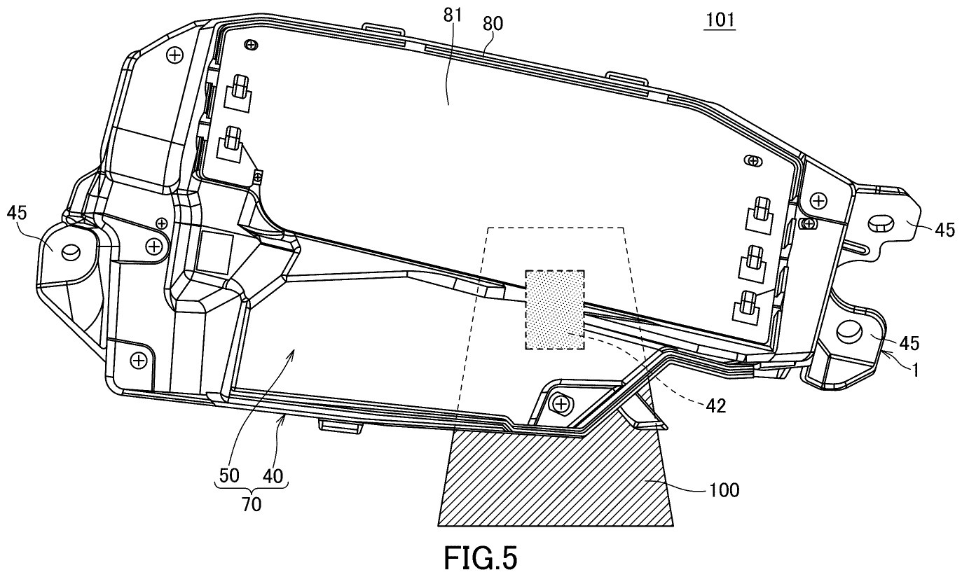

In such attachment structure 101 of the HUD device 1 to the vehicle C, in order to reduce the virtual image blurring due to the vibrations, as shown in FIG. 2, FIG. 5, FIG. 6 and the like, a first elastic member 42, a second elastic member 43, and a third elastic member 44 are provided. They are made of a material that can be elastically compressed and elastically restored, for example, can be adopted as the sponge or the urethane foam and the like.

The first elastic member (equivalent as an “elastic member”) 42 is provided between the protrusion portion 41 provided in the lower case 40 and the vehicle body structure 100. According to the present example, the first elastic member 42 is attached to the protrusion portion 41, however, it may be attached to the vehicle body structure 100. The attachment means may be adopted as an adhesive agent, an adhesive tape, or the like.

The first elastic member 42 is formed in a sheet shape, with one surface thereof is entirely in contact with the protrusion portion 41 and the other surface thereof is entirely in contact with the vehicle body structure 100.

The second elastic member 43 is provided between a rear surface (a surface not at the side of the reflection surface) of the concave mirror 20 and the internal surface of the lower case 40. According to the present example, the second elastic member 43 is attached to the internal surface of the lower case 40, however, it may be attached to the rear surface of the concave mirror 20. The attachment means may be adopted as an adhesive agent, an adhesive tape, or the like. The second elastic member 43 is formed in a sheet shape, with one surface thereof is entirely in contact with the internal surface of the lower case 40 and the other surface thereof is entirely in contact with the rear surface of the concave mirror 20. Also, the second elastic member 43, in the entire rotatable range of the concave mirror 20 (that is, in the case in which the concave mirror 20 is at any position in the rotatable range), is in contact with the internal surface of the lower case 40 and the rear surface of the concave mirror 20.

The third elastic member (equivalent as an “elastic member”) 44 is provided between a bracket 45 provided in the lower case 40 and the vehicle body structure 100. The third elastic member 44 is formed in an annular shape, and is positioned at the outer circumference of the bolt insertion hole 45a. The bolt is inserted through the bolt insertion hole 45a and then fastened to the vehicle body structure 100 such that the third elastic member 44 is in contact with the bracket 45 and the vehicle body structure 100 in a compressed state.

The first elastic member 42 and the third elastic member 44 suppress the housing 70 from vibrating relative to the vehicle C due to the influence of the vibrations from the vehicle C side. That is, the vibrations that are not synchronized with the vibrations of the vehicle C are suppressed from occurring at the housing 70 side. The second elastic member 43 suppresses the concave mirror 20 from vibrating relative to the housing 70 due to the influence of the vibrations from the vehicle C side and the influence of the driving of the rotation means 24. Due to such circumstances, it is possible to reduce the virtual image blurring. Also, the first elastic member 42 is provided near the gravity center of the HUD device 1 such that it does not only reduce the vibrations but also stabilizes the installation balance of the HUD device 1 assembled into the vehicle C.

Also, regarding the present attachment structure 101, it is possible to adjust the shape and size of the protrusion portion 41 and the elastic members 42, 43, 44 and the contact range or the like corresponding to the vehicle body structure 100 such that the countermeasures with respect to the virtual image blurring can be implemented for variations of vehicles. Also, the rigidity of the members being in contact with each of the elastic members 42, 43, 44 are different, however, by adjusting each rigidity of the elastic members 42, 43, 44, it is possible to realize the countermeasures with respect to the virtual image blurring in response to the members to be in contact with.

Furthermore, according to the present example, the plurality of elastic members 42, 43, 44 are provided, however, it is sufficient that at least the first elastic member 42 is provided. By providing the second elastic member 43 and the third elastic member 44 in addition to the first elastic member 42, it is possible to further reduce the virtual image blurring, and at meanwhile, it is possible to accelerate the convergence of the vibrations by these elastic members 42, 43, 44.

It is noted that the above-described embodiment merely shows a typical aspect of the present invention, and the present invention is not limited to this embodiment. That is, various modifications can be made without departing from the scope of the invention. Of course, such modifications will fall within the scope of the present invention as long as they still have the configurations according to the present invention.

### REFERENCE SIGNS LIST

1 head-up display device
10 display light
20 concave mirror (reflection member)
21 plane mirror
30 display device
40 lower case
41 protrusion portion
42 first elastic member (elastic member)
43 second elastic member
44 third elastic member (elastic member)
45 bracket
50 upper case
70 housing
100 vehicle body structure
101 attachment structure of head-up display device to vehicle
C vehicle
Ws window shield

1. An attachment structure of a head-up display device to a vehicle, wherein between a housing of the head-up display device and the vehicle, an elastic member being in contact therewith is arranged.

2. The attachment structure of a head-up display device to a vehicle according to claim 1,
wherein the housing includes a lower case and an upper case that are assembled with each other, and
a protrusion portion is provided in the lower case such that the elastic member is attached to the protrusion portion.

3. The attachment structure of a head-up display device to a vehicle according to claim 1,
wherein a bracket is arranged to be fixed to the vehicle with a bolt, and
the elastic member is arranged between the bracket and the vehicle.

4. The attachment structure of a head-up display device to a vehicle according to claim 1,
wherein the head-up display device comprises:
the housing;
a reflection member being supported by the housing to be freely rotatable; and
a display device configured to project display light on a window shield via the reflection member,
wherein between the housing and the reflection member, a second elastic member being in contact therewith is arranged.
